(19) United States
(12) Patent Application Publication
(10) Pub. No.: US 2026/0186965 A1
(43) Pub. Date: Jul. 2, 2026

(54) DEVICE CONFIGURATION BY A SAMPLE DEVICE

(71) Applicant: Micron Technology, Inc., Boise, ID (US)

(72) Inventors: Gaurav Sinha, Unterschleißheim (DE); Marco Redaelli, München (DE)

(21) Appl. No.: 19/426,158

(22) Filed: Dec. 19, 2025

Related U.S. Application Data
(60) Provisional application No. 63/740,255, filed on Dec. 30, 2024.

(51) Int. Cl. G06F 12/06

(52) U.S. Cl. CPC G06F 12/0646

(57) ABSTRACT

Methods, systems, and devices for device configuration by a sample device are described. The memory system may receive a first vendor unique command to generate a binary file representing a fully configured memory system. The fully configured memory system may include a region of a memory array, a boot partition, and a security configuration. In some cases, the memory system may generate the binary file for configuring a second memory system based on receiving the first command. The binary file may include metadata and one or more image files. The memory system may transmit the binary file to a system for configuring the second memory system based on receiving a second vendor unique command.

### CROSS REFERENCE

The present Application for Patent claims priority to U.S. Patent Application No. 63/740,255 by Sinha et al., entitled “DEVICE CONFIGURATION BY A SAMPLE DEVICE,” filed Dec. 30, 2024, which is assigned to the assignee hereof, and which is expressly incorporated by reference in its entirety herein.

### TECHNICAL FIELD

The following relates to one or more systems for memory, including device configuration by a sample device.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports device configuration by a sample device in accordance with examples as disclosed herein.

FIG. 2 shows an example of a flow diagram that supports device configuration by a sample device in accordance with examples as disclosed herein.

FIG. 3 shows a block diagram of a memory system that supports device configuration by a sample device in accordance with examples as disclosed herein.

FIG. 4 shows a flowchart illustrating a method or methods that support device configuration by a sample device in accordance with examples as disclosed herein.

### DETAILED DESCRIPTION

A memory system may initially be configured and programmed, which may include namespace configuration, boot partition setups, security data programming, and the like. In some cases, forming the namespace, programming the boot partitions, and managing the security data may be performed in separate, distinct steps. In such cases, configuring and programming memory systems in a production setting may be relatively inefficient and time-consuming due to the steps involving coordination and sequencing. In some systems, the memory system may be power cycled after it is configured and programmed to ensure data integrity and configuration accuracy. The complexity of programming and configuring one or more memory systems may lead to increased production time, higher costs, and potential for errors when scaling to programming relatively large volumes of memory systems.

Systems, devices, and techniques are described to improve security and safety of the memory system, thereby improving the overall efficiency and operations of the programming operation(s). In some memory systems, techniques for streamlining the programming process of a memory system are described. Techniques for using a fully configured memory system (e.g., to generate a golden sample) and vendor specific (VU) commands are further disclosed. By extracting the entire device configuration and data content from the fully configured memory system into a single binary file, other memory systems may be programmed in a single operation, which may decrease the programming time and increase the overall efficiency of programming such memory systems.

The programming operation may use a fully configured memory system (e.g., sample device) to generate a golden sample which serves as the reference model for programming additional systems. The sample memory system may receive a first VU command to generate a single binary file that represents the fully configured memory system having an already configured namespace formation (e.g., a region of a memory array), boot partition, security configuration, and the like. The sample memory system may generate the binary file based on receiving the first VU command. The binary file may be used to configure one or more memory systems using metadata and one or more images stored to the sample memory system. The sample system may then transmit the binary file to a system including one or more memory systems based on receiving a second VU command. In such cases, the system may be configured in a single step after receiving the binary file and extracting the metadata and one or more images.

By consolidating the entire device configuration and data into a single binary file, the techniques described herein simplify the programming workflow, reduce error rates, and improve production efficiency. While the initial set up to configure the sample device may involve relatively complex steps for configuring namespaces, boot partitions, and security data, the binary file may allow for relatively fast and consistent reimaging of new memory systems, thereby ensuring uniformity across all memory systems produced using the binary file and maintaining high quality and consistency. In such cases, programming one or more memory systems using the single binary file may increase the reliability and security of the memory system, thereby allowing the memory system or other components to perform operations at improved speeds, efficiency, and performance.

In addition to applicability in memory systems as described herein, techniques for configuring a device using a sample memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices improving memory access speeds, which may decrease processing or latency times, improve response times, or otherwise improve user experience, among other benefits.

Features of the disclosure are illustrated and described in the context of systems, devices, and circuits. Features of the disclosure are further illustrated and described in the context of a flow diagram and flowcharts.

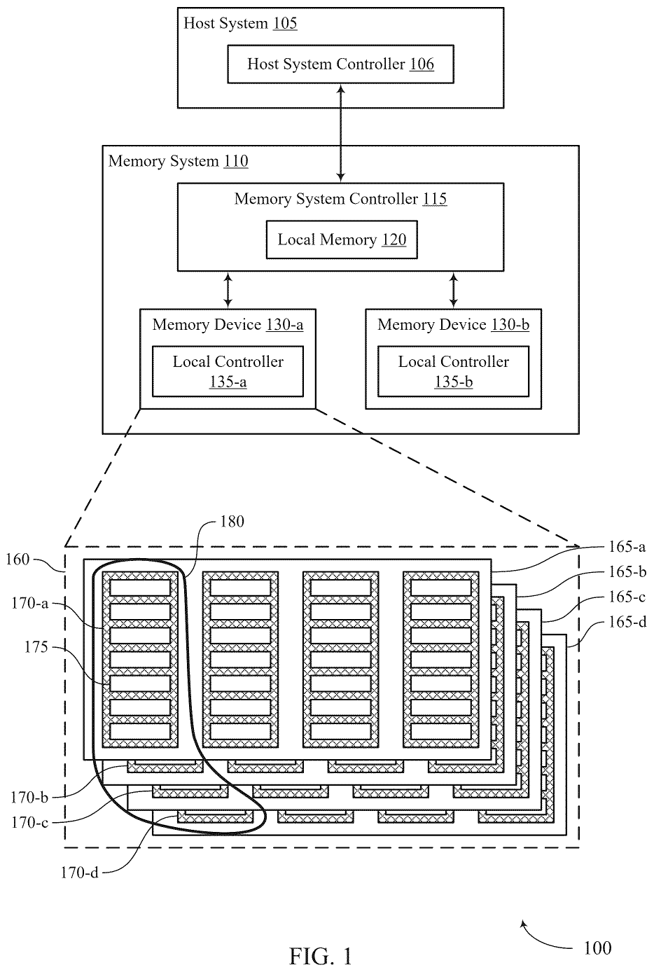

FIG. 1 shows an example of a system 100 that supports device configuration by a sample device in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some examples, the memory system 110 may receive a first command (e.g., a first VU command) to generate a single binary file representing a fully configured memory system 110 that includes a region of a memory array (e.g., namespace formation), a boot partition, and a security configuration. In some cases, the memory system 110 may generate the single binary file for configuring a second memory system based on receiving the first command. The single binary file may include metadata and one or more image files. The memory system 110 may then transmit the single binary file to a system for configuring the second memory system based on receiving a second command (e.g., a second VU command).

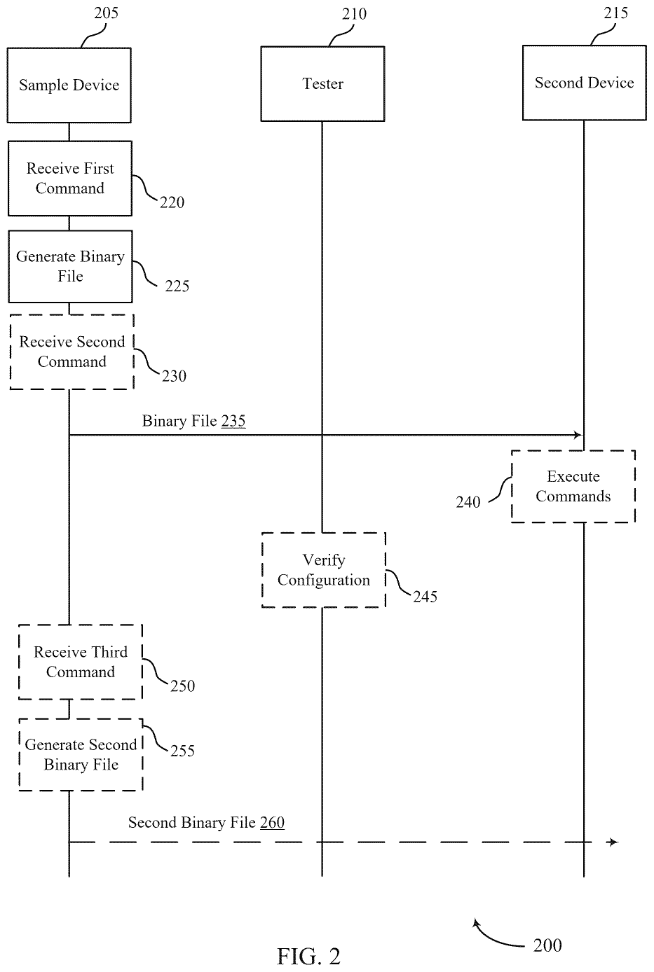

FIG. 2 shows an example of a flow diagram 200 that supports device configuration by a sample device in accordance with examples as disclosed herein. Flow diagram 200 may include a sample device 205 (e.g., the sample device 205 may be an example of a memory system 110 as described with reference to FIG. 1) and a second device 215 (e.g., the second device 215 may be an example of a memory system 110 as described with reference to FIG. 1). Flow diagram 200 may also include a tester 210. The steps performed by the sample device 205 in flow diagram 200 may be implemented in instructions stored on memory of memory system 110 executed by the memory system controller 115.

Alternative examples of the following may be implemented, where some steps are performed in a different order or not at all. Some steps may additionally include additional features not mentioned below. The flow diagram 200 illustrates techniques for using a fully configured sample device to transfer the entire configuration and data content into a single binary file and apply the configuration and data content to one or more systems (e.g., devices) in a single step.

Aspects of the flow diagram 200 may be implemented by one or more controllers, among other components. Additionally, or alternatively, aspects of the flow diagram 200 may be implemented as instructions stored in one or more memories (e.g., firmware stored in one or more memories coupled with the memory system). For example, the instructions, when executed by one or more controllers (e.g., the memory system controller 115), may cause the one or more controllers (or a device or system) to perform the operations of the flow diagram 200.

In some other systems, a device (e.g., a sample device, a second device) may be programmed by receiving a series of commands to program various features of the device. For example, device programming may include multiple configuration steps such namespace configuration, boot partition set up, boot partition programming, security data programming, and security data management. Due to the programming of devices involving multiple, complex steps, configuring and programming devices in a production setting may be cumbersome and time-consuming which may lead to increased production time, higher costs, and potential for errors, especially when scaling to large volume of devices.

Systems, devices, and techniques are described to program devices by using a golden sample (e.g., a configuration stored to the sample device 205) and custom VU commands. The golden sample may be or may be associated with a fully configured memory system that serves as the reference model for programming additional memory systems (e.g., second device 215). As described herein, a VU command may be employed to extract the entire device configuration and data content from the sample device 205 and into a single binary file (e.g., configuration file including the configuration details and the user data content of the sample device 205). The generated single binary file may be used to program new systems with a single command that loads the generated binary file onto the second device 215 (and other memory systems, not shown). The single command may apply the entire configuration and data in a single step, thereby eliminating the use for multiple programming commands.

Such techniques may simplify the programming workflow by reducing complexities, improving efficiency, reducing error rates, and maintaining consistency in mass production environments. By reducing the programming process to a single command and single binary file, the time to configure and program each second device 215 may be significantly decreased, thereby enhancing throughput in production environments. Using the golden sample (e.g., the sample device 205) may ensure that each second device 215 is programmed with identical configurations and data, thereby minimizing variability and errors across multiple memory systems. In such cases, read access to specified LBA ranges may be protected, thereby improving the security and safety of the memory system, and allowing the memory system or other components to perform operations at improved speeds, efficiency, and performance.

At 220, a first command may be received. For example, the sample device 205 may receive the first command to generate the binary file. The binary file may represent a fully configured memory system that includes namespace formation, a boot partition, and a security configuration, among other configurations. The namespace formation may be an example of a TLC block, an SLC block, an MLC block, and/or a QLC block that instructs the second device 215 to configure a portion of the drive to store a particular quantity of bits per cell (e.g., to operate as a SLC, MLC, TLC, QLC, etc.). In such cases, the namespace formation may be an example of forming or otherwise configuring a region of a device of the respective memory system.

In some cases, the sample device 205 may load the metadata and the one or more image files associated with the namespace formation, the boot partition, and the security configuration before receiving the first command. To configure the sample device 205, the sample device 205 may be configured with multiple settings such as namespace formation, boot partition programming, and security data set up. The sample device 205 may be programmed using standard commands to create a complete and verified configuration. In such cases, a single device (e.g., the sample device 205) may be set up to include all the content to be written (e.g., including a downloaded image) to other systems.

The first command may be an example of a VU command. The first command may be issued on the sample device 205 where the sample device 205 may read the configuration and create the binary file based on receiving the first command. The first command may be sent by a preprocessor to the sample device 205. The first command may be an example of a read configuration command that includes instructions (e.g., to the sample device 205) to read the configuration of the sample device 205 and generate a single binary file using the read configuration. In other examples, the first command may be an example of any command sent to the sample device 205 (and subsequently issued on the sample device 205).

At 225, the binary file may be generated. For example, the sample device 205 may generate the binary file for configuring a second memory system (e.g., a second device 215) based on receiving the first command. The binary file may include metadata and one or more image files. The first command may include instructions (e.g., to the sample device 205) to generate a single binary file using the read configuration from the sample device 205. During the binary file creation, the first command may be employed to extract the entire configuration and data content from the sample device 205 into a single binary file. The binary file may include the metadata about the device configuration as well as images from each namespace, boot partition, and security data. The sample device 205 may process the first command to identify the configurations and generate the binary file to include the configurations.

In one example, the configuration of the sample device 205 may include four namespaces which may be read from the sample device 205 after receiving the first command. The sample device 205 may generate the binary file to include the four namespaces and may instruct the second device 215 to be configured with the four namespaces from the sample device 205.

At 230, a second command may be received. For example, the sample device 205 may receive the second command to load the binary file to the second device 215. The second command may be received after generating the binary file. The second command may be an example of a VU command.

The second command may be utilized to load the binary file to a relatively new second device 215 (e.g., an unprogrammed second device 215). The second command may apply the entire configuration and data in a single step, thereby eliminating the use of multiple programming commands to be sent and executed at the second device 215. The second command may be an example of a write configuration command that includes instructions to write the configuration to the second device 215.

At 235, the binary file may be transmitted. For example, the sample device 205 may transmit the binary file to a system (e.g., the tester 210, the second device 215, or both) for configuring the second device 215 based on receiving the second command. That is, the binary file may be transmitted to the tester 210 for configuring the second device 215. In some cases, the sample device 205 may transmit the binary file to the second device 215 in response to receiving the second command.

In some cases, the binary file may be transmitted to the second device 215 directly (e.g., without the intervention of the tester 210). In other examples, the binary file may be transmitted to second device 215 via the tester 210 such that the tester 210 may verify the configuration prior to relaying the binary file to the second device 215. The tester 210 may be an example of an intermediary device that stores the binary file and then uploads the binary file to other memory systems (e.g., including the second device 215). The tester 210 may be an example of a programming system.

At 240, the commands may be executed. For example, the second device 215 may execute the commands included in the binary file. The binary file may be configured to be executed by the second device 215 to configure the second device 215 with the namespace formation, the boot partition, and the security configuration identical to the namespace formation, the boot partition, and the security configuration from the sample device 205. In such cases, the second device 215 may receive and execute the binary file to configure the second device 215. For example, the second device 215 may use the generated binary file to configure the second device 215.

In some cases, the binary file may include a bitmap of a list of sequential commands to be executed by the second device 215. For example, the second device 215 may receive the binary file, execute the list of sequential commands, and configure the second device 215. In such cases, the second device 215 may be configured during a single operation rather than receiving multiple commands and executing each command as the command is received at the second device 215. The second device 215 may be configured by applying the entire configuration in the binary file to the second device 215.

In some examples, the binary file may include a plurality of SSD registers that are saved from one device to another device (e.g., second device 215) without implying a command. In such cases, the binary file including the plurality of SSD registers may allow for a more direct transfer of configuration data from the sample device 205 to the second device 215, thereby ensuring that the second device 215 is configured identically to the sample device 205. By including the plurality of SSD registers, the binary file may provide an overview of the state of the memory system (e.g., the sample device 205), which may be used to replicate the configuration across multiple devices efficiently and accurately.

At 245, the configuration may be verified. For example, the second device 215, the tester 210, or both may verify the configuration. The binary file may include a first checksum value for verifying that the second device 215 was configured. In such cases, a checksum value may be used to verify the configuration of another memory system (e.g., the second device 215). The second device 215 may report back, to the tester 210, the sample device 205, or both, a checksum value that matches the checksum value of the binary file for an efficient and quick verification of the image and the entire configuration. The checksum verification process may allow for relatively quick confirmation that the second device 215 has been correctly imaged and configured.

At 250, a third command may be received. For example, the sample device 205 may receive the third command to generate a second binary file representing the fully configured memory system. In such cases, the second binary file may be used to configure a third memory system (e.g., including one or more other devices). The second binary file may be different from the first binary file. Thus, the second device 215 may be configured with a first binary file and a first configuration, and the third memory system may be configured with a second binary file and a second configuration. The third command may be an example of a VU command.

At 255, a second binary file may be generated. For example, the sample device 205 may generate the second binary file for configuring the third memory system based on receiving the third command. The second binary file may include the metadata and the one or more image files.

At 260, the second binary file may be transmitted. For example, the sample device 205 may transmit the second binary file to the system (e.g., the tester 210, one or more other devices, or a combination thereof) for configuring the third memory system based on receiving a fourth command. The fourth command may be an example of a VU command.

Such techniques may reduce the complexity of programming multiple memory systems by simplifying the programming workflow that would otherwise execute complex sequences of commands. In some cases, efficiency of programming one or more memory systems may be improved by reducing the programming process to a single command (e.g., transmitting the binary file after receiving the second VU command). In such cases, the time to configure and program each device may be decreased. Using the single binary file to configure devices may enhance throughput in production environments and maintain consistency in mass production environments by being able to program new devices with a single command. By using a golden sample, the system may ensure that each device is programmed with identical configurations and data, thereby minimizing variability and errors across multiple devices.

The process of programming devices with a single binary file may be easily scalable, thereby allowing for deployment of large volumes of devices without additional complexity and reducing overall error rates with fewer manual steps. In such cases, the likelihood of programming errors and data inconsistencies may be reduced. By improving efficiency and reducing error rates, manufacturers may achieve cost savings through faster production cycles and reduced rework.

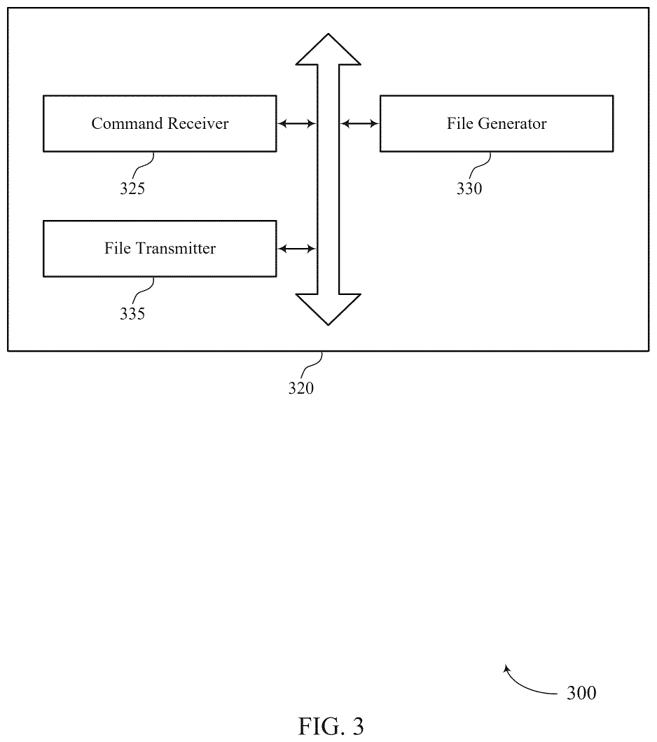

FIG. 3 shows a block diagram 300 of a memory system 320 that supports device configuration by a sample device in accordance with examples as disclosed herein. The memory system 320 may be an example of aspects of a memory system as described with reference to FIGS. 1 through 2. The memory system 320, or various components thereof, may be an example of means for performing various aspects of device configuration by a sample device as described herein. For example, the memory system 320 may include a command receiver 325, a file generator 330, a file transmitter 335, or any combination thereof. Each of these components, or components of subcomponents thereof (e.g., one or more processors, one or more memories), may communicate, directly or indirectly, with one another (e.g., via one or more buses).

The command receiver 325 may be configured as or otherwise support a means for receiving a first command to generate a binary file representing a fully configured memory system that includes a region of a memory array, a boot partition, and a security configuration. The file generator 330 may be configured as or otherwise support a means for generating the binary file for configuring a second memory system based on receiving the first command, the binary file including metadata and one or more image files. The file transmitter 335 may be configured as or otherwise support a means for transmitting the binary file to a system for configuring the second memory system based on receiving a second command.

In some examples, the command receiver 325 may be configured as or otherwise support a means for receiving the second command to load the binary file to the memory system based on generating the binary file, where the binary file is transmitted to the second memory system based on receiving the second command.

In some examples, the binary file is configured to be executed by the second memory system to configure the second memory system with the region of the memory array, the boot partition, and the security configuration.

In some examples, the file generator 330 may be configured as or otherwise support a means for loading the metadata and the one or more image files associated with the region of the memory array, the boot partition, and the security configuration before receiving the first command.

In some examples, the binary file includes a first checksum value for verifying that the second memory system was configured.

In some examples, the binary file includes a bitmap of a list of sequential commands to be executed by the second memory system.

In some examples, the command receiver 325 may be configured as or otherwise support a means for receiving a third command to generate a second binary file representing the fully configured memory system. In some examples, the file generator 330 may be configured as or otherwise support a means for generating the second binary file for configuring a third memory system based on receiving the first command, the second binary file including the metadata and the one or more image files. In some examples, the file transmitter 335 may be configured as or otherwise support a means for transmitting the second binary file to the system for configuring the third memory system based on receiving a fourth command.

In some examples, the first command and the second command each include a VU command.

In some examples, the binary file is transmitted to a tester for configuring the second memory system.

In some examples, the second memory system is configured during a single operation.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

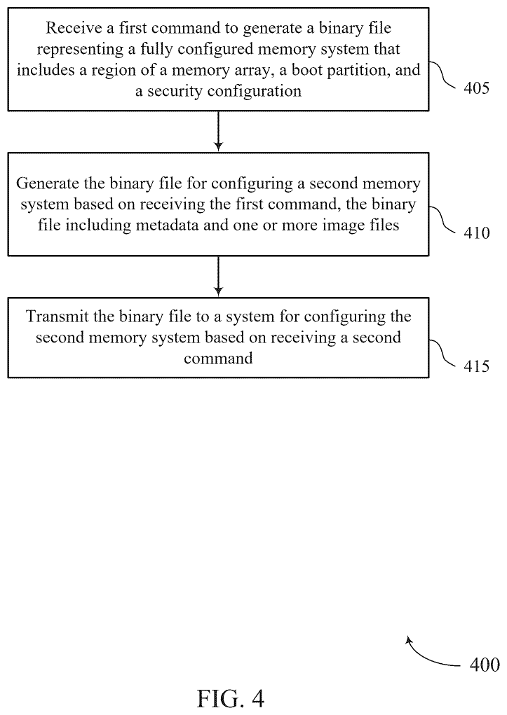

FIG. 4 shows a flowchart illustrating a method 400 that supports device configuration by a sample device in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include receiving a first command to generate a binary file representing a fully configured memory system that includes a region of a memory array, a boot partition, and a security configuration. In some examples, aspects of the operations of 405 may be performed by a command receiver 325 as described with reference to FIG. 3. For example, the memory system may include command receiver 325 that receives a first command (e.g., VU command) to generate a binary file representing a fully configured memory system (e.g., sample device 205 of FIG. 2) that includes the region of the memory array, a boot partition, and a security configuration—e.g., as described herein, including with reference to the operations described at 220 of FIG. 2.

At 410, the method may include generating the binary file for configuring a second memory system based on receiving the first command, the binary file including metadata and one or more image files. In some examples, aspects of the operations of 410 may be performed by a file generator 330 as described with reference to FIG. 3. For example, the memory system may include file generator 330 that generates the binary file for configuring a second memory system (e.g., second device 215) based on receiving the first command—e.g., as described herein, including with reference to the operations described at 225 of FIG. 2.

At 415, the method may include transmitting the binary file to a system for configuring the second memory system based on receiving a second command. In some examples, aspects of the operations of 415 may be performed by a file transmitter 335 as described with reference to FIG. 3. For example, the memory system may include file transmitter 335 that transmits the binary file to a system (e.g., tester 210 and/or second device 215) for configuring the second memory system based on receiving a second command—e.g., as described herein, including with reference to the operations described at 235 of FIG. 2.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a first command to generate a binary file representing a fully configured memory system that includes a region of a memory array, a boot partition, and a security configuration; generating the binary file for configuring a second memory system based on receiving the first command, the binary file including metadata and one or more image files; and transmitting the binary file to a system for configuring the second memory system based on receiving a second command.

Aspect 2: The method, apparatus, or non-transitory computer-readable medium of aspect 1, further including operations, features, circuitry, logic, means, or instructions, or any combination thereof for receiving the second command to load the binary file to the memory system based on generating the binary file, where the binary file is transmitted to the second memory system based on receiving the second command.

Aspect 3: The method, apparatus, or non-transitory computer-readable medium of any of aspects 1 through 2, where the binary file is configured to be executed by the second memory system to configure the second memory system with the region of the memory array, the boot partition, and the security configuration.

Aspect 4: The method, apparatus, or non-transitory computer-readable medium of any of aspects 1 through 3, further including operations, features, circuitry, logic, means, or instructions, or any combination thereof for loading the metadata and the one or more image files associated with the region of the memory array, the boot partition, and the security configuration before receiving the first command.

Aspect 5: The method, apparatus, or non-transitory computer-readable medium of any of aspects 1 through 4, where the binary file includes a first checksum value for verifying that the second memory system was configured.

Aspect 6: The method, apparatus, or non-transitory computer-readable medium of any of aspects 1 through 5, where the binary file includes a bitmap of a list of sequential commands to be executed by the second memory system.

Aspect 7: The method, apparatus, or non-transitory computer-readable medium of any of aspects 1 through 6, further including operations, features, circuitry, logic, means, or instructions, or any combination thereof for receiving a third command to generate a second binary file representing the fully configured memory system; generating the second binary file for configuring a third memory system based on receiving the first command, the second binary file including the metadata and the one or more image files; and transmitting the second binary file to the system for configuring the third memory system based on receiving a fourth command.

Aspect 8: The method, apparatus, or non-transitory computer-readable medium of any of aspects 1 through 7, where the first command and the second command each include a vendor unique (VU) command.

Aspect 9: The method, apparatus, or non-transitory computer-readable medium of any of aspects 1 through 8, where the binary file is transmitted to a tester for configuring the second memory system.

Aspect 10: The method, apparatus, or non-transitory computer-readable medium of any of aspects 1 through 9, where the second memory system is configured during a single operation.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a first command to generate a binary file representing a fully configured memory system that includes a region of a memory array, a boot partition, and a security configuration;
generate the binary file for configuring a second memory system based on receiving the first command, the binary file comprising metadata and one or more image files; and
transmit the binary file to a system for configuring the second memory system based on receiving a second command.

2. The memory system of claim 1, wherein the processing circuitry is further configured to cause the memory system to:
receive the second command to load the binary file to the memory system based on generating the binary file, wherein the binary file is transmitted to the second memory system based on receiving the second command.

3. The memory system of claim 1, wherein the binary file is configured to be executed by the second memory system to configure the second memory system with the region of the memory array, the boot partition, and the security configuration.

4. The memory system of claim 1, wherein the binary file comprises a first checksum value for verifying that the second memory system was configured.

5. The memory system of claim 1, wherein the binary file comprises a bitmap of a list of sequential commands to be executed by the second memory system.

6. The memory system of claim 1, wherein the first command and the second command each comprise a vendor unique (VU) command.

7. The memory system of claim 1, wherein the binary file is transmitted to a tester for configuring the second memory system.

8. The memory system of claim 1, wherein the second memory system is configured during a single operation.

9. A method at a memory system, comprising:
receiving a first command to generate a binary file representing a fully configured memory system that includes a region of a memory array, a boot partition, and a security configuration;
generating the binary file for configuring a second memory system based on receiving the first command, the binary file comprising metadata and one or more image files; and
transmitting the binary file to a system for configuring the second memory system based on receiving a second command.

10. The method of claim 9, further comprising:
receiving the second command to load the binary file to the memory system based on generating the binary file, wherein the binary file is transmitted to the second memory system based on receiving the second command.

11. The method of claim 9, wherein the binary file is configured to be executed by the second memory system to configure the second memory system with the region of the memory array, the boot partition, and the security configuration.

12. The method of claim 9, wherein the binary file comprises a first checksum value for verifying that the second memory system was configured.

13. The method of claim 9, wherein the binary file comprises a bitmap of a list of sequential commands to be executed by the second memory system.

14. The method of claim 9, wherein the first command and the second command each comprise a vendor unique (VU) command.

15. The method of claim 9, wherein the binary file is transmitted to a tester for configuring the second memory system.

16. The method of claim 9, wherein the second memory system is configured during a single operation.

17. A non-transitory computer-readable medium storing code, the code comprising instructions executable by one or more processors to:
receive a first command to generate a binary file representing a fully configured memory system that includes a region of a memory array, a boot partition, and a security configuration;
generate the binary file for configuring a second memory system based on receiving the first command, the binary file comprising metadata and one or more image files; and
transmit the binary file to a system for configuring the second memory system based on receiving a second command.

18. The non-transitory computer-readable medium of claim 17, wherein the instructions are further executable by the one or more processors to:
receive the second command to load the binary file to the memory system based on generating the binary file, wherein the binary file is transmitted to the second memory system based on receiving the second command.

19. The non-transitory computer-readable medium of claim 17, wherein the binary file is configured to be executed by the second memory system to configure the second memory system with the region of the memory array, the boot partition, and the security configuration.

20. The non-transitory computer-readable medium of claim 17, wherein the binary file comprises a first checksum value for verifying that the second memory system was configured.

21. The non-transitory computer-readable medium of claim 17, wherein the binary file comprises a bitmap of a list of sequential commands to be executed by the second memory system.

22. The non-transitory computer-readable medium of claim 17, wherein the first command and the second command each comprise a vendor unique (VU) command.

23. The non-transitory computer-readable medium of claim 17, wherein the binary file is transmitted to a tester for configuring the second memory system.

24. The non-transitory computer-readable medium of claim 17, wherein the second memory system is configured during a single operation.
